(19) United States
(12) Patent Application Publication
(10) Pub. No.: US 2010/0050110 A1
(43) Pub. Date: Feb. 25, 2010

(54) INTEGRATION VIEWER SYSTEMS AND METHODS OF USE

(75) Inventors: William D. Hughes, Bainbridge Island, WA (US); Christopher McQuistin, Seattle, WA (US); Mark Morita, Arlington Heights, IL (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/194,042

(22) Filed: Aug. 19, 2008

(51) Int. Cl. G06F 3/048

(52) U.S. Cl. 715/781

(57) ABSTRACT

Certain embodiments provide systems and methods for graphical representation of patient information with respect to patient anatomy. Certain embodiments provide an integrated patient information viewer system. The system includes a user interface displaying a graphical representation of a patient anatomy denoting one or more areas of the representation of the patient anatomy having information related to a patient and accepting user input with respect to the graphical representation. The system also includes a processor processing user input via the user interface to the information related to the patient corresponding to a selected area of the representation. The processor provides the information for the selected area of the representation via the user interface. The information provides further visual detail regarding the selected area of the patient anatomy.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The present disclosure generally relates to patient anatomical representation. More particularly, the present disclosure relates to graphical representation of patient information using an anatomical index.

Healthcare practice has become centered around electronic data and records management. Hospitals typically utilize computer systems to manage the various departments within a hospital, and data about each patient is collected by a variety of computer systems through a variety of interfaces and forms. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access and/or distribute patient information or other information at various points in a healthcare workflow.

As digital EMRs become more standard, providers have an increasingly difficult time in navigating the full record to find data of interest to them. This issue will only increase as more data is entered into the EMR, and providers are under time pressure to quickly find relevant data.

Currently, most healthcare information systems display patient information textually in spreadsheet format. These systems are very active and display a wealth of information that is often not relevant to the healthcare provider at the time of interaction. The complexity of these screens cause professionals to spend their time searching to find the appropriate kernel of information rather than focusing on the diagnosis or interventional plan of a patient.

### BRIEF SUMMARY OF THE INVENTION

Certain embodiments provide systems and methods for graphical representation of patient information with respect to patient anatomy.

Certain embodiments provide an integrated patient information viewer system. The system includes a user interface displaying a graphical representation of a patient anatomy denoting one or more areas of the representation of the patient anatomy having information related to a patient and accepting user input with respect to the graphical representation. The system also includes a processor processing user input via the user interface to the information related to the patient corresponding to a selected area of the representation. The processor provides the information for the selected area of the representation via the user interface. The information provides further visual detail regarding the selected area of the patient anatomy.

Certain embodiments provide a method for integrating patient information via a graphical viewer. The method includes generating an anatomical index for a patient from medical data for the patient. The method also includes displaying the anatomical index as a graphical representation of the patient anatomy. The graphical representation of the anatomical index denotes one or more areas associated with medical data for the patient. The method further includes accepting user input with respect to the anatomical index. Additionally, the method includes displaying information with respect to the anatomical index in response to the user input The information provides further visual detail regarding the selected area of the patient anatomy.

Certain embodiments provide a machine-readable medium having a set of instructions for execution by a processor. The set of instructions includes an anatomical index generation routine generating an anatomical index for a patient from medical data for the patient The set of instructions also includes a graphical representation display routine displaying the anatomical index as a graphical representation of the patient anatomy. The graphical representation of the anatomical index denotes one or more areas associated with medical data for the patient. The set of instructions further includes an input routine accepting user input with respect to the anatomical index. Additionally, the set of instructions includes an output routine retrieving and displaying information with respect to the anatomical index in response to the user input. The information provides farther visual detail regarding the selected area of the patient anatomy.

### BRIEF DESCRIPTION OF SEVERAL VIEWS OF THE DRAWINGS

FIG. 1 illustrates an example integration viewer in accordance with certain aspects or embodiments.

FIG. 2 illustrates a flow diagram for a method for representing patient medical information via an anatomical index in accordance with certain aspects or embodiments.

FIG. 3 shows a block diagram of an example clinical information system capable of implementing the example methods and systems described herein to provide an integration viewer with an anatomical index and patient representation in accordance with certain aspects or embodiments.

FIG. 4 depicts a block diagram of an example processing system for providing an integration viewer with an anatomical index and patient representation in accordance with certain aspects or embodiments.

FIG. 5 is a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain aspects or embodiments provide anatomical index representing a patient. The anatomical index graphically represents patient problems with respect to all or portion(s) of the displayed anatomy. Patient problems can be characterized as general or local to one or more areas of the patient's body based on user preferences and/or clinical algorithms, for example. In certain embodiments, the anatomical index depicts a three-dimensional (“3D”) view of the human body including the existence of localized problems based on sections or parts of the anatomy. For example a number of documented clinical problems for a patient can be represented in the anatomical index, and systematic problems can be shown in the anatomical index as well.

In certain embodiments, users can view clinical content associated with a certain section of the body by activating the section of the body of interest via the graphical representation of the anatomical index. In certain embodiments, users can filter a view of the representation and/or related clinical content based on a certain time period and/or other criterion(-ia), for example. In certain embodiments, clinical content from multiple data sources can be interrelated and retrieved via the single integrated view of the anatomical index.

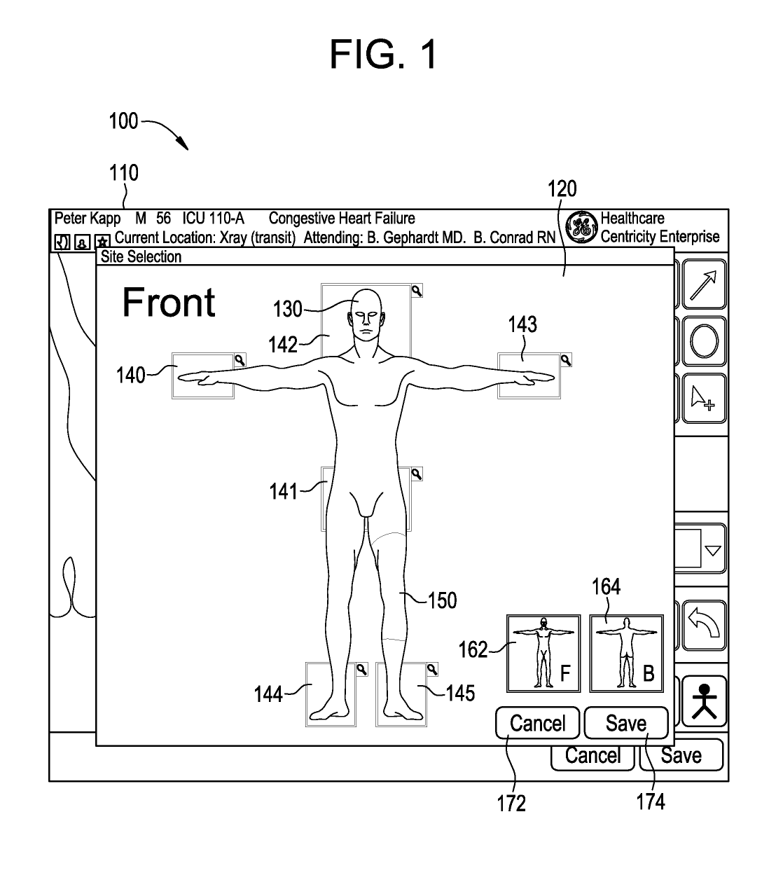

FIG. 1 illustrates an example integration viewer 100 in accordance with certain aspects or embodiments of the present invention. As shown in FIG. 1, the integration viewer 100 includes a user interface 110 including an anatomical index 120. The example anatomical index 120 shown in FIG. 1 includes a representation 130 of a human body, one or more areas 140-145 for further magnification, and one or more highlighted portions 150 of the anatomy indicating patient problem information. The anatomical index 120 shown in FIG. 1 also includes an indication of view 160, one or more alternative view selectors 162 and 164, and one or more option icons such as cancel 172 and save 174.

In certain embodiments, the representation 130 can be customized, at least to a certain extent, based on the particular patient being reviewed. For example, if the patient is male, then the representation 130 can generally or more specifically depict male anatomy. Similarly, if the patient is female, then the representation 130 can generally or more specifically depict female anatomy. As an alternative or additional example, if the patient is short, tall, fat, thin, etc., such characteristics can be generally or more specifically depicted in the graphical representation 130. For example, a library of representation templates may be used to match a representation 130 with available patient information, which can then be completed with relevant patient information for storage and/or display.

In certain embodiments, the integration viewer 100 integrates retrieval, storage, and/or modification of clinical content from one or more sources through a graphical anatomical index 120. Patient problems can be characterized as general or localized problems, with the anatomical index 120 linked to the problem. Using a two-dimensional (“2D”) and/or 3D representation 130, a user may select all or part of the representation 130 to view linked records and/or other clinical information.

Patient problems, symptoms, conditions, etc., associated with an anatomical attribute can be assigned to a record, such as an electronic medical record for the patient, and displayed in the representation 130 of the anatomical index 120, for example. A user can click on or otherwise select all or part of the representation image 130 instead of typing in a search term, for example. The user can graphically traverse down through a hierarchy and reach a patient record (or particular portion thereof) related to a particular anatomical area and/or problem. A patient symptom/condition/problem can be linked to the anatomical index and to a record, such as an electronic medical record, for example.

Using the anatomical index 120 and representation 130, a user can more easily select patient body area(s) for review based on the depicted anatomy. In certain embodiments, easy selection can be facilitated using a touch screen interface. Certain embodiments can be used with touch screen applications. Certain embodiments can be used with a pointing device based system to move a cursor and click or otherwise select a location in the representation 130. Certain embodiments provide an alternative to typing in text or selecting from a pick list but still capturing structured data related to the patient and/or patient problem.

In certain embodiments, the representation 130 provides an anatomical representation with highlighting and/or other emphasis to identify one or more portion(s) 150 representing patient problem areas. The problem area and representation information can be captured as structured data in association with one or more images in an electronic medical record and/or separate image file associated with a specific problem, for example.

In certain embodiments, a user can enter information such as by obtaining a picture of a patient wound, identifying where the wound is located on the patient anatomy, and providing the image and related information to the system 100 for incorporation into the anatomical index 120. In certain embodiments, the user can also add notes to the wound entry, for example. In certain embodiments, the image and location information in the index 120 and representation 130 can be used in conjunction with supplemental information to provide assistance to a clinical user. In certain embodiments, information can be selectively copied and pasted to and from an external document via the user interface 110.

As shown, for example, in FIG. 1, the 2D or 3D anatomical rendering 130 includes certain areas 140-145 where a user can magnify the representation 130. For example, the patient's head, hands, pelvis, and feet can be magnified or otherwise drilled down. For example, a user can drill down into a specific hand area without having to use an entirely different sheet or display as would occur in paper forms. At a higher level, for example, a user can see highlighting for a problem area 150 and can drill down there as well to see what specifically is wrong.

The indication of view 160 informs a user as to what perspective or view of the patient is being provided through the representation 130. For example, a front view, back view, side view, top view, bottom view, etc., can be provided in the representation 130. In certain embodiments, one or more view selectors, such as view selectors 162 and 164, allow a user to transition between different representation 130 views. In certain embodiments, the representation 130 can provide a 360-degree fly around view.

In certain embodiments, as shown in FIG. 1, one or more option icons allow a user to interact with the content of the user interface 110 including the anatomical index 120 and representation 130. For example, the cancel button 172 cancels user input and the save button 172 allows the user to save input and/or other modification of interface 110 content.

In certain embodiments, the integration viewer 100 can be implemented as a tablet computing device with an integrated camera. A user can click a button to pull up a camera interface and click again to take a picture. The tablet device captures the image and pulls up an anatomical selector. For example, the user can click on a knee in the anatomical representation and then save the picture in conjunction with the knee representation. Alternatively and/or in addition, the user can type in a description of the location or select from a list of items. In certain embodiments, the viewer 100 facilitates a single click system to identify a problem area and save data in relation to that selected problem area, for example.

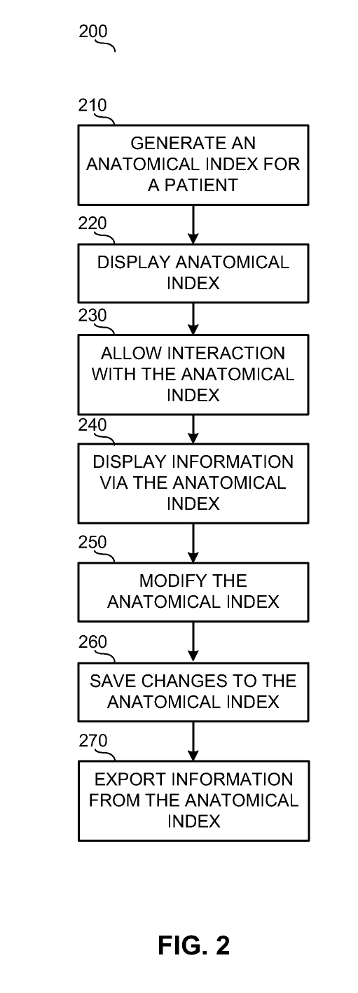

FIG. 2 illustrates a flow diagram for a method 200 for representing patient medical information via an anatomical index. At 210, an anatomical index is generated for a patient. For example, the anatomical index can be generated for a patient from patient medical record and/or other data. The anatomical index can highlight and/or otherwise provide reference to one or more general or anatomically localized problems and/or areas of interest for the patient, for example.

At 220, the anatomical index is displayed to a user via a user interface. For example, a two or three dimensional representation of a human body is displayed to a user via a monitor or other display, such as a tablet computer display. The anatomical index representation can be displayed alone and/or in conjunction with other information, such as patient identification information, patient medical history information, clinical application execution options, and/or other clinical and/or administrative functionality.

At 230, a user can interact with the anatomical index. For example, a user can manipulate a pointing device (e.g., a mouse, trackball, scroll wheel, touchpad, pointing stick, etc.), keyboard, keypad, joystick, touch screen, etc., to position a cursor/indicator over and/or otherwise select an area of the displayed anatomy. In certain embodiments, the user can interact with the anatomical index to drill down into the displayed anatomy, for example. In certain embodiments, the user can request additional information and/or execution of clinical application(s) by selecting and/or otherwise interacting with one or more areas of the anatomical index, for example.

At 240, requested information stemming from the user interaction is displayed. For example, selecting a representation of the patient's left knee, as illustrated for example in FIG. 1, can result in a magnified view of the knee and/or a selected portion of the leg being displayed for the information. As an alternative or additional example, selection of the patient's left knee in the anatomical index can bring up related information regarding that portion of the patient's anatomy, such as new images, past images, reference images, patient data, lab results, exam notes, etc. As an alternative or additional example, selection of the patient left knee in the anatomical index can allow the user to “drill down” deeper into that portion of the patient anatomy including, for example, lower level views of blood vessels, bone, muscle, etc., in the form of further representations and associated information, images, and the like.

At 250, a user can modify the anatomical index. For example, if the user has obtained additional examination notes, lab results, observations, etc., regarding a portion of the patient's anatomy (e.g., the patient's knee), the user can annotate or otherwise enter the information with respect to the selected anatomy. As an alternative or additional example, the user can associate image(s) (such as newly obtained CT image(s) of the patient's knee) with the selected area of the patient's anatomy in the anatomical index. In certain embodiments, input can be globally associated with the entire patient anatomy, for example.

At 2603 changes to the anatomical index are saved. For example, added images and/or alphanumeric information input by the user and/or automatically associated with the anatomical index via a clinical application are saved as part of the anatomical index and/or in association with the patient and/or the patient's anatomical index to be used the next time the anatomical index is displayed and/or otherwise retrieved.

At 270, information from the anatomical index can be exported. For example, updated and/or added information regarding the patient can be transferred from the anatomical index to the patient's electronic medical record, to a clinical application, and/or to other clinical data storage, for example. For example, additional image, laboratory, and/or examination data entered in association with the anatomical index can be forwarded to a computer aided diagnosis (“CAD”) application to aid in patient diagnosis. As another example, information can be used to trigger a scheduler to request subsequent tests and/or appointments for the patient as a result of the new and/or updated information.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

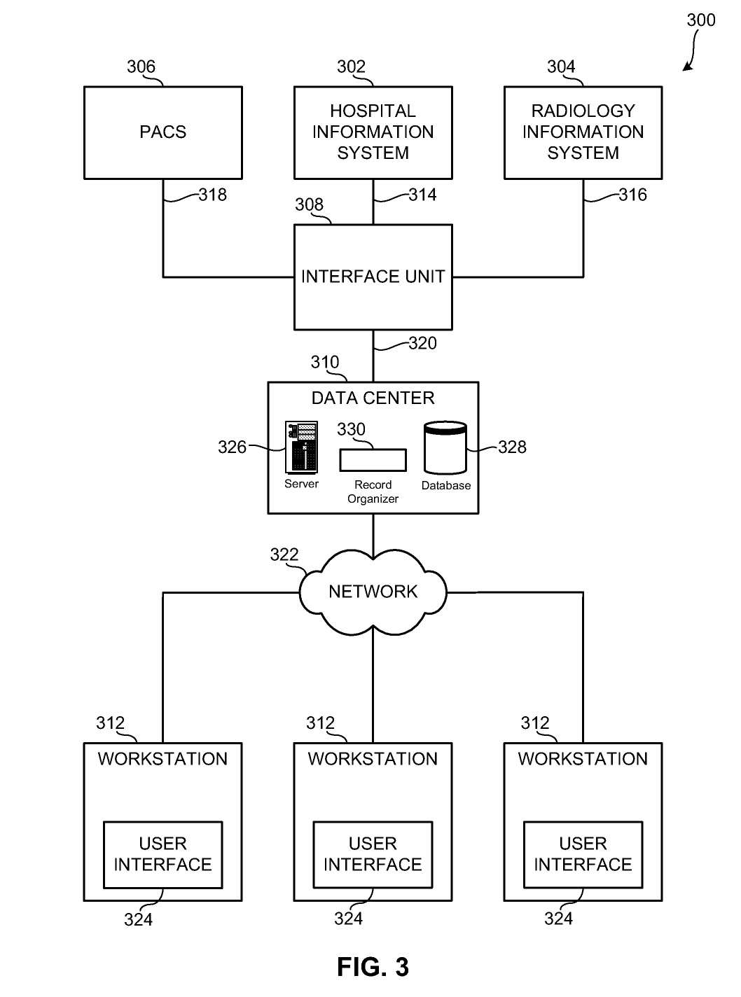

FIG. 3 shows a block diagram of an example clinical information system 300 capable of implementing the example methods and systems described herein to provide an integration viewer with an anatomical index and patient representation. The example clinical information system 300 includes a hospital information system (“HIS”) 302, a radiology information system (“RIS”) 304, a picture archiving and communication system (“PACS”) 306, an interface unit 308, a data center 310, and a plurality of workstations 312. In the illustrated example, the HIS 302, the RIS 304, and the PACS 306 are housed in a healthcare facility and locally archived. However, in other implementations, the HIS 302, the RIS 304, and/or the PACS 306 may be housed one or more other suitable locations. Furthermore, one or more components of the clinical information system 300 may be combined and/or implemented together. For example, the RIS 304 and/or the PACS 306 may be integrated with the HIS 302; the PACS 306 may be integrated with the RIS 304; and/or the three example information systems 302, 304, and/or 306 may be integrated together. In other example implementations, the clinical information system 300 includes a subset of the illustrated information systems 302, 304, and/or 306. For example, the clinical information system 300 may include only one or two of the HIS 302, the RIS 304, and/or the PACS 306. Preferably, information (e.g., test results, observations, diagnosis, etc.) is entered into the HIS 302, the RIS 304, and/or the PACS 306 by healthcare practitioners (e.g., radiologists, physicians, and/or technicians) before and/or after patient examination.

The HIS 302 stores medical information such as clinical reports, patient information, and/or administrative information received from, for example, personnel at a hospital, clinic, and/or a physician's office. The RIS 304 stores information such as, for example, radiology reports, messages, warnings, alerts, patient scheduling information, patient demographic data, patient tracking information, and/or physician and patient status monitors. Additionally, the RIS 304 enables exam order entry (e.g., ordering an x-ray of a patient) and image and film tracking (e.g., tracking identities of one or more people that have checked out a film). In some examples, information in the RIS 304 is formatted according to the HL-7 (Health Level Seven) clinical communication protocol.

The PACS 306 stores medical images (e.g., x-rays, scans, three-dimensional renderings, etc.) as, for example, digital images in a database or registry. In some examples, the medical images are stored in the PACS 306 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 306 for storage. In some examples, the PACS 306 may also include a display device and/or viewing workstation to enable a healthcare practitioner to communicate with the PACS 306.

The interface unit 308 includes a hospital information system interface connection 314, a radiology information system interface connection 316, a PACS interface connection 318, and a data center interface connection 320. The interface unit 308 facilities communication among the HIS 302, the RIS 304, the PACS 306, and/or the data center 310. The interface connections 314, 316, 318, and 320 may be implemented by, for example, a Wide Area Network (“WAN”) such as a private network or the Internet. Accordingly, the interface unit 308 includes one or more communication components such as, for example, an Ethernet device, an asynchronous transfer mode (“ATM”) device, an 802.11 device, a DSL modem, a cable modem, a cellular modem, etc. In turn, the data center 310 communicates with the plurality of workstations 312, via a network 322, implemented at a plurality of locations (e.g., a hospital, clinic, doctor's office, other medical office, or terminal, etc.). The network 322 is implemented by, for example, the Internet, an intranet, a private network, a wired or wireless Local Area Network, and/or a wired or wireless Wide Area Network. In some examples, the interface unit 308 also includes a broker (e.g., a Mitra Imaging's PACS Broker) to allow medical information and medical images to be transmitted together and stored together.

In operation, the interface unit 308 receives images, medical reports, administrative information, and/or other clinical information from the information systems 302, 304, 306 via the interface connections 314, 316, 318. If necessary (e.g., when different formats of the received information are incompatible), the interface unit 308 translates or reformats (e.g., into Structured Query Language (“SQL”) or standard text) the medical information, such as medical reports, to be properly stored at the data center 310. Preferably, the reformatted medical information may be transmitted using a transmission protocol to enable different medical information to share common identification elements, such as a patient name or social security number. Next, the interface unit 308 transmits the medical information to the data center 310 via the data center interface connection 320. Finally, medical information is stored in the data center 310 in, for example, the DICOM format, which enables medical images and corresponding medical information to be transmitted and stored together.

The medical information is later viewable and easily retrievable at one or more of the workstations 312 (e.g., by their common identification element, such as a patient name or record number). The workstations 312 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 312 receive commands and/or other input from a user via, for example, a keyboard, mouse, track ball, microphone, etc. As shown in FIG. 3, the workstations 312 are connected to the network 322 and, thus, can communicate with each other, the data center 310, and/or any other device coupled to the network 322. The workstations 312 are capable of implementing a user interface 324 to enable a healthcare practitioner to interact with the clinical information system 300. For example, in response to a request from a physician, the user interface 324 presents a patient medical history. Additionally, the user interface 324 includes one or more options related to the example methods and apparatus described herein to organize such a medical history using classification and severity parameters.

The example data center 310 of FIG. 3 is an archive to store information such as, for example, images, data, medical reports, and/or, more generally, patient medical records. In addition, the data center 310 may also serve as a central conduit to information located at other sources such as, for example, local archives, hospital information systems/radiology information systems (e.g., the 1IS 302 and/or the RIS 304), or medical imaging/storage systems (e.g., the PACS 306 and/or connected imaging modalities). That is, the data center 310 may store links or indicators (e.g., identification numbers, patient names, or record numbers) to information. In the illustrated example, the data center 310 is managed by an application server provider (ASP) and is located in a centralized location that may be accessed by a plurality of systems and facilities (e.g., hospitals, clinics, doctor's offices, other medical offices, and/or terminals). In some examples, the data center 310 may be spatially distant from the HIS 302, the RIS 304, and/or the PACS 306 (e.g., at General Electric® headquarters).

The example data center 310 of FIG. 3 includes a server 326, a database 328, and a record organizer 330. The server 326 receives, processes, and conveys information to and from the components of the clinical information system 300. The database 328 stores the medical information described herein and provides access thereto. The example record organizer 330 of FIG. 3 manages patient medical histories, for example.

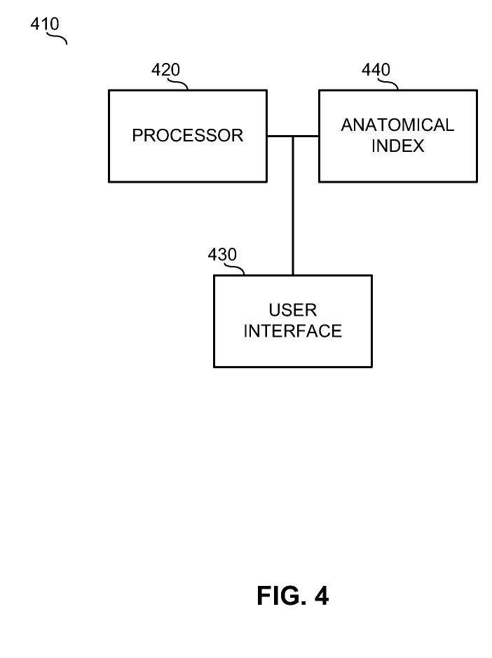

FIG. 4 depicts a block diagram of an example processing system 410 for providing an integration viewer with an anatomical index and patient representation. As shown in FIG. 4, the processing system 410 includes a processor 420, a user interface 430, and an anatomical index 440. The processor 420 may be any suitable processor, processing unit, or microprocessor, for example. Although not shown in FIG. 4, the system 410 may be a multi-processor system and, thus, may include one or more additional processors that are identical or similar to the processor 412 and that are communicatively coupled through a bus or other connection, for example.

The processor 420 includes and/or is in communication with a memory that includes instructions and data for providing the user interface 430 for display to and interaction with a user, for example. The anatomical index 440 provides a graphical representation (e.g., a 2D and/or 3D image) of a patient body including one or more indications or references to patient information. For example, the graphical representation in the anatomical index 440 can include a highlighted arm indicating a current and/or prior broken arm for tie patient. The anatomical index 440 is displayed via the user interface 430. The user interface 430 allows a user to interact with the index 440 to retrieve and/or input information related to the represented patient. User input is processed by the processor 420 with respect to the information in the index 440. 511 In operation, the processor 420 generates and/or retrieves from electronic storage the anatomical index 440 for a patient. For example, the anatomical index 440 can be generated for a patient from patient medical record and/or other data. The anatomical index 440 can highlight and/or otherwise provide reference to one or more general or anatomically localized problems and/or areas of interest for the patient, for example. The anatomical index is displayed via the user interface 430. For example, a two or three dimensional representation of a human body is displayed to a user via a monitor or other display, such as a tablet computer display. The anatomical index 440 representation can be displayed alone and/or in conjunction with other information, such as patient identification information, patient medical history information, clinical application execution options, and/or other clinical and/or administrative functionality, via the user interface 430.

The user can interact with the anatomical index 440 via a user interface 430 input. For example, a user can manipulate a pointing device (e.g., a mouse, trackball, scroll wheel, touchpad, pointing stick, etc.), keyboard, keypad, joystick, touch screen, etc., to position a cursor/indicator over and/or otherwise select an area of the displayed anatomy. In certain embodiments, the user can interact with the anatomical index 440 to drill down into the displayed anatomy, for example. In certain embodiments, the user can request additional information and/or execution of clinical application(s) by selecting and/or otherwise interacting with one or more areas of the anatomical index 440, for example.

The processor 420 receives user input via the user interface 430 and processes the user input with respect to the anatomical index 440. Requested information stemming from the user interaction is displayed via the user interface 430. For example, selecting a representation of the patient's left knee, as illustrated for example in FIG. 1, can result in a magnified view of the knee and/or a selected portion of the leg being displayed via the user interface 430. As an alternative or additional example, selection of the patient's left knee in the anatomical index 440 can bring up related information regarding that portion of the patient's anatomy, such as new images, past images, reference images, patient data, lab results, exam notes, etc. As an alternative or additional example, selection of the patient left knee in the anatomical index 440 can allow the user to “drill down” deeper into that portion of the patient anatomy including, for example, lower level views of blood vessels, bone, muscle, etc., in the form of further representations and associated information, images, and the like.

User input can also trigger the processor 420 to modify the anatomical index 440. For example, if the user has obtained additional examination notes, lab results, observations, etc., regarding a portion of the patient's anatomy (e.g., the patient's knee), the user can annotate or otherwise enter the information with respect to the selected anatomy via the user interface 430. As an alternative or additional example, the user can associate image(s) (such as newly obtained CT images) of the patient's knee) with the selected area of the patient's anatomy in the anatomical index 440. In certain embodiments, input can be globally associated with the entire patient anatomy, for example.

In addition to modifying the anatomical index 440, the processor 420 can propagate information from the anatomical index 440 to electronic storage, a clinical system, a clinical application, etc. For example, added images and/or alphanumeric information input by the user and/or automatically associated with the anatomical index 440 via a clinical application can be saved as part of the anatomical index 440 and/or in association with the patient and/or the patient's anatomical index 440 to be used the next time the anatomical index 440 is displayed and/or otherwise retrieved. As another example, updated and/or added information regarding the patient can be transferred from the anatomical index 440 to the patient's electronic medical record, to a clinical application, and/or to other clinical data storage, for example. For example, additional image, laboratory, and/or examination data entered in association with the anatomical index 440 can be forwarded to a CAD application to aid in patient diagnosis. As another example, information can be used to trigger a scheduler to request subsequent tests and/or appointments for the patient as a result of the new and/or updated information.

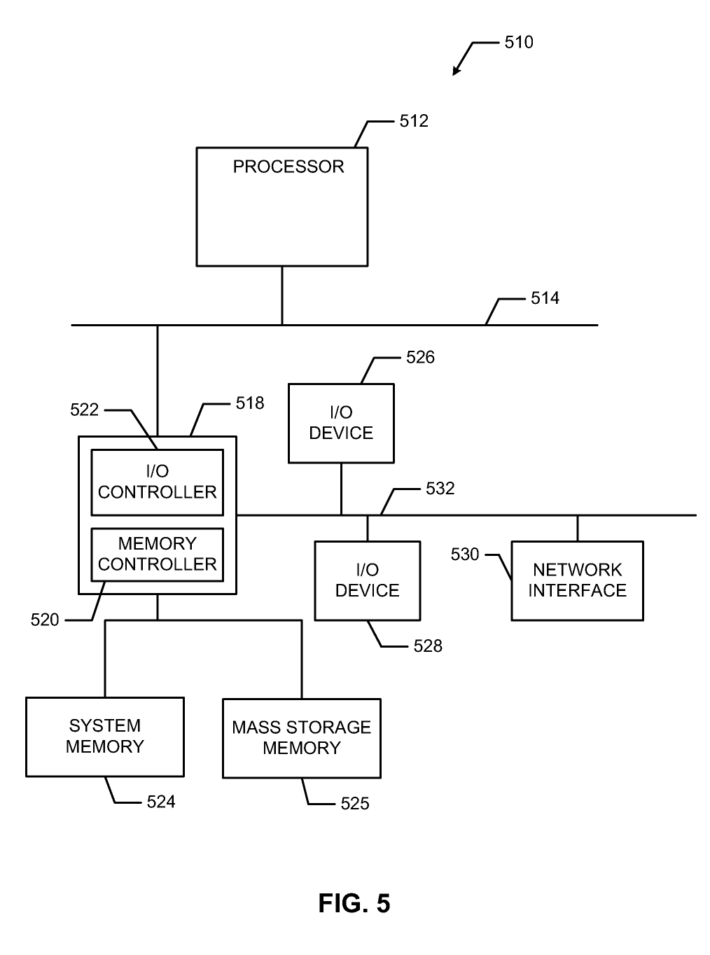

FIG. 5 is a block diagram of an example processor system 510 that may be used to implement systems and methods described herein. As shown in FIG. 5, the processor system 510 includes a processor 512 that is coupled to an interconnection bus 514. The processor 512 may be any suitable processor, processing unit, or microprocessor, for example. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (“I/O”) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (“ATM”) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Thus, certain embodiments provide alternative and more intuitive view(s) of a patient's clinical encounters than a text-based medical record or report format. Certain embodiments allow users to more quickly drill down into area(s) of interest in the patient anatomy and associated medical records. Certain embodiments provide visualization tools to help users to navigate available data and sources of data. Visualization of relevant clinical data utilizing a representation of the human form helps to enable a simpler navigational paradigm for interacting with relevant patient data. Certain embodiments provide a technical effect of a front end user interface that allows healthcare providers to more easily navigate a patient's medical record with contextual data populated in a just-in-time fashion, for example.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

For example, certain embodiments can be implemented as a machine-readable medium having a set of instructions for execution by a processor. The set of instructions includes an anatomical index generation routine generating an anatomical index for a patient from medical data for the patient. The set of instructions also includes a graphical representation display routine displaying the anatomical index as a graphical representation of said patient anatomy. The graphical representation of the anatomical index denotes one or more areas associated with medical data for the patient. The set of instructions also includes an input routine accepting user input with respect to the anatomical index. Additionally, the set of instructions includes an output routine retrieving and displaying information with respect to said anatomical index in response to the user input. The information provides further visual detail regarding the selected area of the patient anatomy.

In certain embodiments, the anatomical index generation routine integrates a plurality of information sources to provide the medical data for the patient to be used in generating the anatomical index and associated graphical representation, for example. In certain embodiments, the input routine accepts user input to add information regarding the patient to an area of the graphical representation and the anatomical index, for example. In certain embodiments, the output routine retrieves and displays one or more associated images and annotations corresponding to the selected area of the patient anatomy in response to the user input, for example.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, band-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. An integrated patient information viewer system, said system comprising:
a user interface displaying a graphical representation of a patient anatomy denoting one or more areas of said representation of said patient anatomy having information related to a patient and accepting user input with respect to said graphical representation; and
a processor processing user input via said user interface to said information related to said patient corresponding to a selected area of said representation, said processor providing said information for said selected area of said representation via said user interface, said information providing further visual detail regarding said selected area of said patient anatomy.

2. A system according to claim 1, wherein said graphical representation comprises a three-dimensional graphical representation.

3. A system according to claim 1, wherein said denoting one or more areas of said representation comprises highlighting said one or more areas of said representation.

4. A system according to claim 1, wherein at least one of said one or more areas of said representation having information related to said patient allow a user to magnify said at least one of said one or more areas for display via said user interface.

5. A system according to claim 1, wherein said user interface displays said graphical representation according to a first view and allows a user to select a second view for display of said graphical representation.

6. A system according to claim 1, wherein said processor integrates a plurality of information sources to provide said information in association with said representation via said user interface.

7. A system according to claim 1, wherein said user interface accepts user input to add information regarding said patient to an area of said graphical representation, said user input processed by said processor for association with said area of said representation.

8. A system according to claim 1, wherein said user interface comprises a touch screen user interface.

9. A system according to claim 1, wherein said user interface accepts user input to annotate one or more of said one or more areas of said representation having information, said information comprising patient image data.

10. A system according to claim 1, wherein said information provides further alphanumeric detail regarding said selected area of said patient anatomy.

11. A method for integrating patient information via a graphical viewer, said method comprising:
generating an anatomical index for a patient from medical data for the patient;
displaying the anatomical index as a graphical representation of said patient anatomy, the graphical representation of the anatomical index denoting one or more areas associated with medical data for the patient;
accepting user input with respect to the anatomical index; and
displaying information with respect to said anatomical index in response to the user input, the information providing further visual detail regarding the selected area of the patient anatomy.

12. A method according to claim 11, wherein denoting one or more areas of the graphical representation comprises highlighting one or more areas of the representation.

13. A method according to claim 11, wherein at least one of the one or more areas of the representation associated with medical data for the patient allow a user to magnify the area for display.

14. A method according to claim 11, further comprising selecting a view of display of the graphical representation.

15. A method according to claim 11, wherein generating the anatomical index further comprises integrating a plurality of information sources to provide the medical data for the patient to be used in generating the anatomical index and associated graphical representation.

16. A method according to claim 11, further comprising accepting user input to add information regarding the patient to an area of the graphical representation and the anatomical index.

17. A machine-readable medium having a set of instructions for execution by a processor, said set of instructions comprising:
an anatomical index generation routine generating an anatomical index for a patient from medical data for the patient;
a graphical representation display routine displaying the anatomical index as a graphical representation of said patient anatomy, the graphical representation of the anatomical index denoting one or more areas associated with medical data for the patient;
an input routine accepting user input with respect to the anatomical index; and
an output routine retrieving and displaying information with respect to said anatomical index in response to the user input, the information providing further visual detail regarding the selected area of the patient anatomy.

18. A machine-readable medium according to claim 17, wherein the anatomical index generation routine integrates a plurality of information sources to provide the medical data for the patient to be used in generating the anatomical index and associated graphical representation.

19. A machine-readable medium according to claim 17, wherein the input routine accepts user input to add information regarding the patient to an area of the graphical representation and the anatomical index.

20. A machine-readable medium according to claim 17, wherein the output routine retrieves and displays one or more associated images and annotations corresponding to the selected area of the patient anatomy in response to the user input.
